(19) United States
(12) Patent Application Publication
(10) Pub. No.: US 2004/0058698 A1
(43) Pub. Date: Mar. 25, 2004

(54) Method and apparatus for supporting location-based group communications

(76) Inventors: Douglas M. Crockett, San Diego, CA (US); Mark Maggenti, Del Mar, CA (US); Eric C. Rosen, Solana Beach, CA (US)

Correspondence Address: Qualcomm Incorporated, Patents Department, 5775 Morehouse Drive, San Diego, CA, 92121-1714, US

(21) Appl. No.: 10/254,144

(22) Filed: Sep. 24, 2002

(51) Int. Cl. H04Q 7/20

(52) U.S. Cl. 455/518; 455/519; 455/517

(57) ABSTRACT

A method and apparatus for joining a requester of a desired service to a local group of providers for the desired service allows the requester of the desired service to instantly get in touch with the local group of providers for the desired service, regardless of the current location of the service requester and without requiring the service requester to individually call each provider of the desired service.

### FIELD

The present invention relates to point to multi-point communications systems. More specifically, the present invention relates to methods and apparatus for joining a user, who has requested for a desired service, to a local group of providers of the desired service, based on the current location of the user.

### BACKGROUND

When a requester of a desired service wishes to contact some local providers of the desired service, the requester of the desired service needs to have access to a list of phone numbers for such providers of the desired service. The requester also needs to search through such list of phone numbers for some specific providers of the desired service that are in the proximity of the requester's current location. Further, the requester needs to individually call each local service provider for obtaining information about the desired service as well as the available service provider. The requester needs to repeat this painstakingly process for each local service provider if the requester desires to select a competitive provider for the desired service. Furthermore, when the requester moves into another city or state, the requester has to obtain a new list of phone numbers for the service providers in the new location. Finding such new list of phone numbers is often time consuming, and would not be practical in emergency cases, such as when a police, an ambulance, or a road service is urgently desired. Currently, a requester of a desired service cannot instantly get in touch with a group of local providers for the desired service, regardless of the current location of the service requester and without requiring the requester to individually call each service provider.

A class of wireless services intended for quick, efficient, one-to-one or one-to-many (group) communication has existed in various forms for many years. In general, these services have been half-duplex, where a user presses a “push-to-talk” (PTT) button on a phone/radio to initiate a group call. If granted the floor, the talker then generally speaks for a few seconds. After the talker releases the PTT button, other users may request the floor. These services have traditionally been used in applications where one person, a “dispatcher,” needs to communicate with a group of people, such as field service personnel or taxi drivers, which is where the “dispatch” name for the service comes from. Similar services have been offered on the Internet and are generally known as “voice chat.”

A key feature of these services is that communication is quick and spontaneous, usually initiated by simply pressing a PTT button, without going through a typical dialing and ringing sequence. Communication in this type of service is generally very short, with individual talk “spurts” being generally on the order of several seconds, and “conversations” lasting possibly a minute or less. The time delay between when the user requests the floor and when the user receives a positive or negative confirmation from a group call server indicating that the user has the floor and may begin speaking is known as PTT latency. PTT latency is a critical parameter for half-duplex group communications systems. As mentioned previously, dispatch services place a priority on short, quick conversations, which makes the service less effective if PTT latency becomes large.

There is a need, therefore, for mechanisms to allow a requester of a desired service to instantly get in touch with a local group of available providers for the desired service, regardless of the current location of the service requester and without requiring the service requester to individually call each service provider.

### SUMMARY

The disclosed embodiments provide novel and improved methods and apparatus for joining a communication device (CD) to a group call in a wireless communication network. In one aspect, the method provides for receiving a request from the CD for initiating a group call for a desired service, determining a current status of the CD, determining a group of providers for the desired service based on the determined current status of the CD, and joining the CD to the determined group. In one aspect, the current status includes the current location of the CD:

In one aspect, a method in a communication device (CD) for joining a group call in a wireless communication network provides for sending a request from the CD to a group call server (GCS) for initiating a group call for a desired service, providing a current status of the CD to the GCS, and receiving a response indicating that the GCS has joined the CD to a group, which provides the desired service, based on the current status of the CD. In one aspect, the current status includes the current location of the CD.

In one aspect, an apparatus for joining a communication device (CD) to a group call in a wireless communication network includes a memory unit, a receiver, a transmitter, and a processor communicatively coupled with the memory unit, the receiver, and the transmitter. The processor is capable of carrying out the above-mentioned methods.

### BRIEF DESCRIPTION OF THE DRAWINGS

The features and advantages of the present invention will become more apparent from the detailed description of the embodiments set forth below when taken in conjunction with the following drawings:

FIG. 1 illustrates a group communications system;

FIG. 2 illustrates an embodiment for a base station and a mobile station in FIG. 1;

FIG. 3 illustrates how several communication devices interact with a group call server;

FIG. 4 illustrates one embodiment for the group call server operating in FIG. 1;

FIG. 5 illustrates a call-setup process according to one embodiment; and

FIG. 6 illustrates a mapping diagram for a target group identification process, according to one embodiment.

### DETAILED DESCRIPTION

Before several embodiments are explained in detail, it is to be understood that the scope of the invention should not be limited to the details of the construction and the arrangement of the components set forth in the following description or illustrated in the drawings. Also, it is to be understood that the phraseology and terminology used herein is for the purpose of description and should not be regarded as limiting.

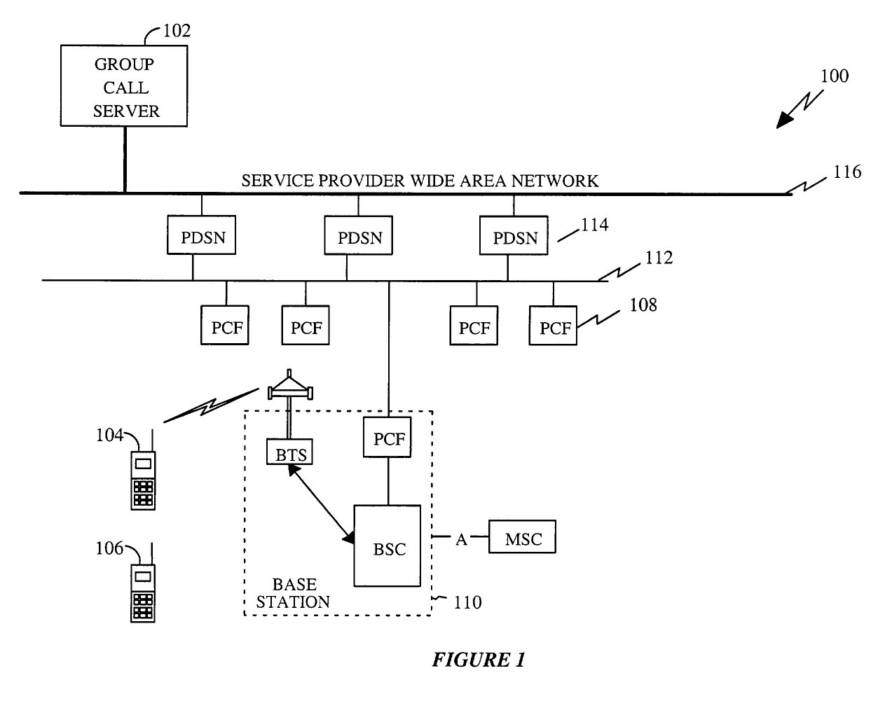

FIG. 1 illustrates a functional block diagram of a group communication system 100, for implementing one embodiment. Group communication system 100 is also known as a push-to-talk (PTT) system, a net broadcast service (NBS), a dispatch system, or a point-to-multi-point communication system. In one embodiment, group communication system 100 includes a group call server 102, which may be deployed in either a centralized deployment or a regionalized deployment.

Group communication devices (CDs) 104 and 106, which may be deployed such as cdma2000 handset, for example, may request packet data sessions using a data service option. Each CD may use the session to register its Internet Protocol (IP) address with the group call server to perform group call initiations. In one embodiment, group call server 102 is connected to the service provider's packet data service nodes (PDSNs) through a service provider's wide area network 116. CDs 104 and 106, upon requesting packet data sessions from the wireless infrastructure, may have IP connectivity to group call server 102 through a PDSN 114. The PDSNs provide interface between transmission of data in the fixed network and the transmission of data over the air interface. Each PDSN may interface to a base station controller (BSC) through a packet control function (PCF) 108 and a network 112. The PCF may be co-located with the BSC within a base station (BS) 110.

A packet data service node may fall in one of several states, e.g., active or connected state, dormant state, and null or inactive state. In the active or connected state, an active traffic channel exists between the participating CD and the BS or BSC, and either side may send data. In the dormant state, no active traffic channel exists between the participating CD and the BSC, but a point-to-point (PPP) link is maintained between the participating CD and the PDSN. In the null or inactive state, there is no active traffic channel between the participating CD and the BSC, and no PPP link is maintained between the participating CD and the PDSN.

After powering up, CDs 104 and 106 may request packet data sessions. As part of establishing a packet data session, each CD may be assigned an IP address. Each CD may perform a registration process to notify group call server 102 of the CD's IP address. Registration may be performed using an IP protocol, such as session initiation protocol (SIP) over user datagram protocol (UDP). The IP address of a CD may be used to contact the CD when the corresponding user is invited into a group call.

Once a group call is established, CDs 104 and 106 and group call server 102 may exchange media and signaling messages. In one embodiment, media may be exchanged between the participating CDs and the group call server by using real-time protocol (RTP) over UDP. The signaling messages may also be exchanged by using a signaling protocol over UDP.

Group communication system 100 performs several different functions in order to operate group call services. The functions that relate to the user side include user registration, group call initiation, group call termination, sending alerts to group participants, late join to a group call, talker arbitration, adding members to a group, removing members from a group, un-registering a member, and authentication. The functions that relate to system preparation and operation include administration and provisioning, scalability, and reliability. These functions are described in detail in the copending patent application entitled, “A Communication Device for Defining a Group in a Group Communication Network,” Attorney Docket No. PA020042, which is assigned to the same assignee and incorporated herein by reference in its entirety.

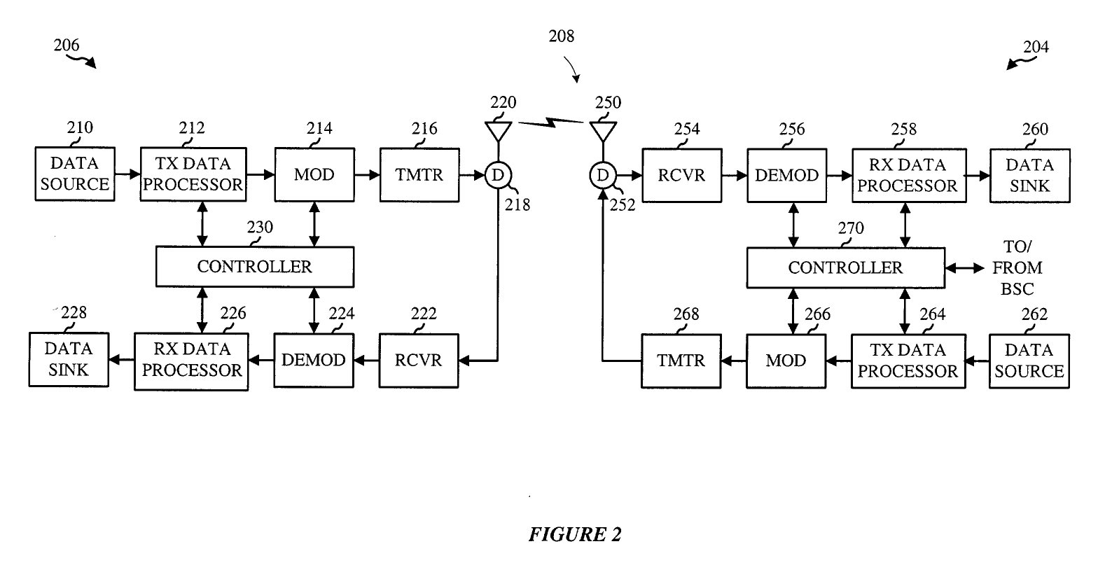

FIG. 2 is a simplified block diagram of an embodiment of base station 204 and mobile station 206, which are capable of implementing various disclosed embodiments. For a particular communication, voice data, packet data, and/or messages may be exchanged between base station 204 and mobile station 206, via an air interface 208. Various types of messages may be transmitted, such as messages used to establish a communication session between the base station and mobile station, registration and paging messages, and messages used to control a data transmission (e.g., power control, data rate information, acknowledgment, and so on). Some of these message types are described in further detail below.

For the reverse link, at mobile station 206, voice and/or packet data (e.g., from a data source 210) and messages (e.g., from a controller 230) are provided to a transmit (TX) data processor 212, which formats and encodes the data and messages with one or more coding schemes to generate coded data. Each coding scheme may include any combination of cyclic redundancy check (CRC), convolutional, turbo, block, and other coding, or no coding at all. The voice data, packet data, and messages may be coded using different schemes, and different types of messages may be coded differently.

The coded data is then provided to a modulator (MOD) 214 and further processed (e.g., covered, spread with short PN sequences, and scrambled with a long PN sequence assigned to the user terminal). The modulated data is then provided to a transmitter unit (TMTR) 216 and conditioned (e.g., converted to one or more analog signals, amplified, filtered, and quadrature modulated) to generate a reverse link signal. The reverse link signal is routed through a duplexer (D) 218 and transmitted via an antenna 220 to base station 204.

At base station 204, the reverse link signal is received by an antenna 250, routed through a duplexer 252, and provided to a receiver unit (RCVR) 254. Base station 204 may receive registration information and status information, e.g., mobile station mobility rate, from mobile station 206. Receiver unit 254 conditions (e.g., filters, amplifies, down converts, and digitizes) the received signal and provides samples. A demodulator (DEMOD) 256 receives and processes (e.g., despreads, decovers, and pilot demodulates) the samples to provide recovered symbols. Demodulator 256 may implement a rake receiver that processes multiple instances of the received signal and generates combined symbols. A receive (RX) data processor 258 then decodes the symbols to recover the data and messages transmitted on the reverse link. The recovered voice/packet data is provided to a data sink 260 and the recovered messages may be provided to a controller 270. Controller 270 may include instructions for paging a group of mobile stations. The processing by demodulator 256 and RX data processor 258 are complementary to that performed at mobile station 206. Demodulator 256 and RX data processor 258 may further be operated to process multiple transmissions received via multiple channels, e.g., a reverse fundamental channel (R-FCH) and a reverse supplemental channel (R-SCH). Also, transmissions may be simultaneously from multiple mobile stations, each of which may be transmitting on a reverse fundamental channel, a reverse supplemental channel, or both.

On the forward link, at base station 204, voice and/or packet data (e.g., from a data source 262) and messages (e.g., from controller 270) are processed (e.g., formatted and encoded) by a transmit (TX) data processor 264, further processed (e.g., covered and spread) by a modulator (MOD) 266, and conditioned (e.g., converted to analog signals, amplified, filtered, and quadrature modulated) by a transmitter unit (TMTR) 268 to generate a forward link signal. The forward link signal is routed through duplexer 252 and transmitted via antenna 250 to mobile station 206. Forward link signals include paging signals.

At mobile station 206, the forward link signal is received by antenna 220, routed through duplexer 218, and provided to a receiver unit 222. Receiver unit 222 conditions (e.g., down converts, filters, amplifies, quadrature modulates, and digitizes) the received signal and provides samples. The samples are processed (e.g., despreaded, decovered, and pilot demodulated) by a demodulator 224 to provide symbols, and the symbols are further processed (e.g., decoded and checked) by a receive data processor 226 to recover the data and messages transmitted on the forward link. The recovered data is provided to a data sink 228, and the recovered messages may be provided to controller 230. Controller 230 may include instructions for registering mobile station 206, determining the status, e.g., location and/or the speed of movement, of the mobile station 206, and providing the status information to the group communication server.

The group call service (GCS) may allow one user to talk to a group of users in a half-duplex or full-duplex mode. In the former case, because only one person may be permitted to talk at a time, the permission to talk may be moderated by the infrastructure. In such systems, a user may request permission to talk by pressing a “push-to-talk” button (PTT), for example. The system may arbitrate the requests received from multiple users and, through a contention-resolution process, the system may choose one of the requesters according to a predetermined algorithm. The system may then notify the chosen user that the user has permission to talk. The system may transparently dispatch the user's traffic information, such as voice and/or data, from the authorized talker to the rest of the group members, who may be considered “listeners.” The voice and/or data traffic in GCS may be different from the classical one-to-one phone call, and a priority may be placed on some conversations.

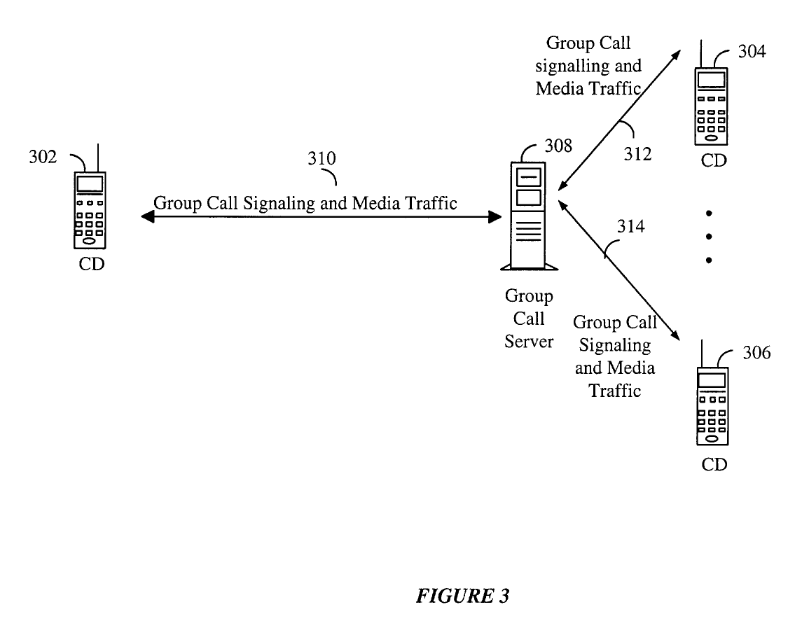

FIG. 3 illustrates a group call arrangement for showing how CDs 302, 304, and 306 interact with a group call server 308. Multiple group call servers may be deployed as desired for large-scale groups. In FIG. 3, when CD 302 has permission to transmit media to other members of the group, CD 302 is known as the talker and may transmit media over an established channel.

When CD 302 is designated as the talker, the remaining participants, CD 304 and CD 306, may not have permission to transmit media to the group. Accordingly, CD 304 and CD 306 are designated as listeners. As described above, CDs 302, 304, and 306 are connected to group call server 308, using at least one channel. In one embodiment, the channel may include a session initiation protocol (SIP) channel, a media-signaling channel, and a media traffic channel.

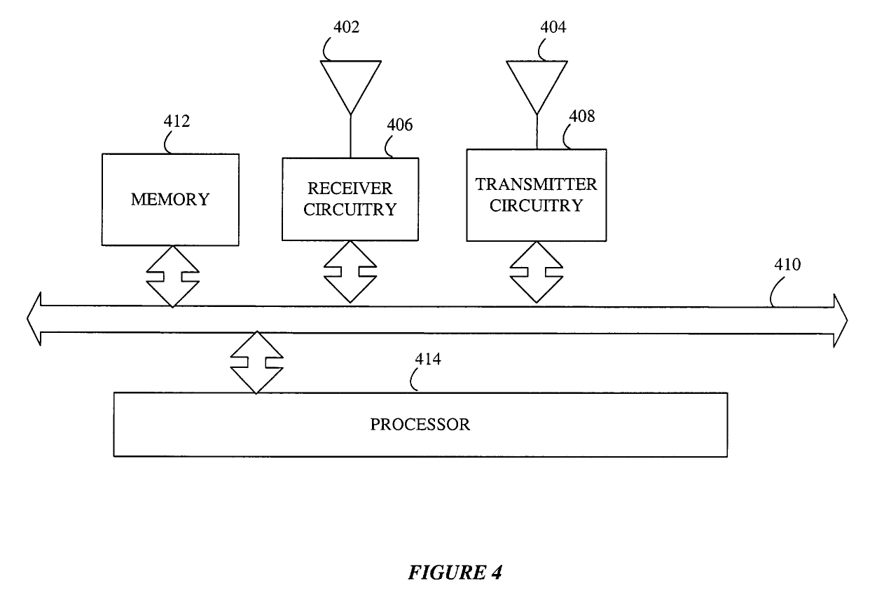

FIG. 4 illustrates one embodiment for the group call server 102 operating in system of FIG. 1. The group call server includes antennas 402, 404 for transmitting and receiving data. Antenna 402 is coupled to the receiver circuitry 406 and antenna 404 is coupled to the transmit circuitry 408. Communication bus 410 provides a common connection among other modules in FIG. 4. Communication bus 410 is further coupled to memory unit 412. Memory 412 stores computer-readable instructions for a variety of operations and functions performed by the group call server. The processor 414 performs the instructions stored in memory 412.

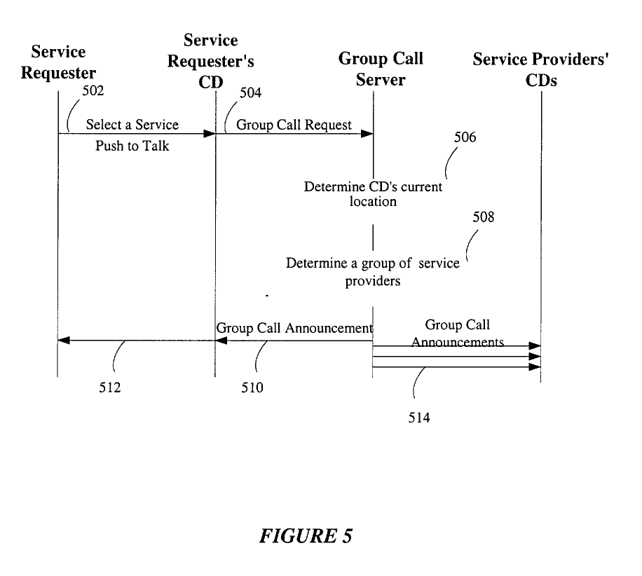

FIG. 5 illustrates a message-flow diagram showing a group-call setup, according to one embodiment. A user who wishes to request a group call for a desired service may select the desired service category 502 and press the push-to-talk (PTT) button on a communication device (CD). The service category may include services such as “taxi,” “pizza,” police,” “ambulance,” and “road service.” The requester's CD may then send a group call request 504 to a group call server to setup a group call with some providers for the selected service category.

The requester's CD may be in a dormant packet data session when the requester initiates the group call. The group call request may be transmitted regardless of whether the requester's CD has a dedicated traffic channel or not, as will be discussed in more details hereinafter. After the group-call request is sent, if the requester's CD is in dormant packet data session, the requester's CD may initiate the process of re-establishing its dedicated traffic channel and prepare the packet data session for media activity.

After the group call server receives the group call request 504, the group call server may determine a current status 506 of the requester's CD. The current status may include information about the current location, current direction of movement, and/or the current speed of movement of the requester's CD. In one embodiment, the group call server may receive the current location and/or speed information from the requester's CD, through some registration or paging process supported by the underlying wireless infrastructure, e.g., cdma2000. After the group call server determines the current status 506 of the requester's CD, the group call server may determine a group of providers 508 of the selected service based on the determined current status of the requester's CD, as will be discussed in more details hereinafter.

The group call server may then send a response 510 back to the requester's CD indicating that a group call is being set up with a target group of providers of the desired service. At this point, the requester's CD may inform 512 the service requester e.g., via text, audio, or video, that the service requester is being connected to the target group of the providers of the desired service. According to one embodiment, the requester's CD may optimistically allow the requester to talk, and the requester's CD may start buffering the media that it may receive from the requester's CD for future transmission to the group call server.

The group call server may use the location information of the target service providers' CDs to send out group-call announcements 514 to the target service providers' CDs. Sending the announcements may trigger the packet data sessions of the target service providers' CDs to come out of dormancy and to re-establish their traffic channels.

In one embodiment, the group communication system supports both chat-room and ad-hoc models for group call services. In the chat-room model, groups are predefined, which may be stored on the group call server. The predefined groups, or nets, may be public, implying that the group has an open member list. In this case, each group member is a potential participant in a group call. The group call is started when a first group member starts to initiate a group call. The call remains running for a pre-determined time period, which may be configured by the group call server. During a group call, the group members may specifically request to join or leave the call. During periods of talk inactivity, the group call may be brought into a group dormant state until a group member requests permission to talk. When operating in the chat-room model, group members, also known as net members, communicate with one another using a communication device assigned to each net member.

In the ad-hoc model of group call services, however, groups may be defined in real-time and have a closed member list associated with each group. A closed member list may specify which members are allowed to participate in the group call. The member list may not be available to others outside of the closed member list, and may only exist for the life of the call. Ad-hoc group definitions may not be stored in the group call server. The definitions may be used to establish the group call and released after the call has ended. An ad-hoc group may be formed after a service requester selects a desired service category and generates a group call request, which is sent to the group call server to start the call. The group call server may send a notification to the target service provider that they have been included in the group. The group call server may automatically join the target service providers to the group call, i.e., no action may be required from the target members. When an ad-hoc call becomes inactive, the group communication server may “tear down” the call and free the resources assigned to the group, including the group definition used to start the call.

In one embodiment, when the packet data service is active, resources in the infrastructure, e.g., base station transceiver subsystem (BTS), base station controller (BSC), packet control function (PCF), and the radio link are actively assigned to the participating CDs. In an IP-based dispatch service, while there is an active conversation going on between group members, the packet data connection for each participating CD remains active. However, after a period of inactivity, i.e., “hang time,” the traffic channels assigned to the participating CDs may be released and the participating CDs may transition to the dormant state.

The transition to the dormant state conserves system capacity and reduces service cost and battery drain. When the packet data sessions are active, even if no data packets are being exchanged, radio frequency (RF) energy may still be transmitted by the participating CDs, albeit at a low level, to maintain synchronization and power control with the base station. These transmissions may cause a significant power drain on the participating CDs. In the dormant state, however, the participating CDs may not perform RF transmission. To conserve power and extend battery life, the hang time may be set to transition the participating CDs to dormant mode after extended periods of no data transmission.

In the case of an active group call, while the packet data services for all participating CDs are active, new PTT requests have very low latency. However, if the participating CDs have previously transitioned to the dormant state, PTT latency may be much longer. During packet data dormancy state, information associated with the packet data session, which may include the CDs' IP address, may be maintained. However, state information associated with layers below PPP, such as physical traffic layers, may be released and/or de-allocated.

In some infrastructures, to wake up dormant packet data sessions, the traffic channels must be reallocated, the resources must be reassigned, and the radio link protocol (RLP) layer must be reinitialized. The effect of this is that after a group has not talked for a while, when a group member presses the PTT button to request the floor, PTT latency for the first talk spurt is generally much longer than for subsequent talk spurts. While this is relatively infrequent, it may affect the utility of the group call service, and should be minimized.

To reduce PTT latency, the group call signaling, such as the group call requests and the group call announcements, may be transmitted on some available common channels. This elimninates waiting for dedicated traffic channels to be re-established. Common channels may be always available, regardless of the state of the participating CDs, and may not require being requested and reassigned each time a group member initiates a group call. Therefore, the group call signaling messages may be exchanged even when the participating CDs are dormant. In one embodiment dedicated traffic channels for the service requester's CD and service providers' CDs may be re-established in parallel.

In one embodiment, media-signaling messages may carry IP datagrams over the reverse link or mobile-originated link. A requester's CD may signal the group call server quickly whenever the talker requests the floor and a dedicated reverse traffic channel is not immediately available. Assuming the requester's CD has released all dedicated traffic channels, the requester's CD may immediately forward the floor control request over a reverse common channel of a wireless infrastructure, which may relay the request to the group call server. For example, either the reverse access channel or the reverse enhanced access channel may be used to send such messages, e.g., in short data burst (SDB) format, when a dedicated reverse channel is not available. In one embodiment, after receiving the floor-control request, the group call server may burst media-signaling messages to a group of dormant service providers' CDs and trigger such CDs to re-establish their dedicated traffic channels.

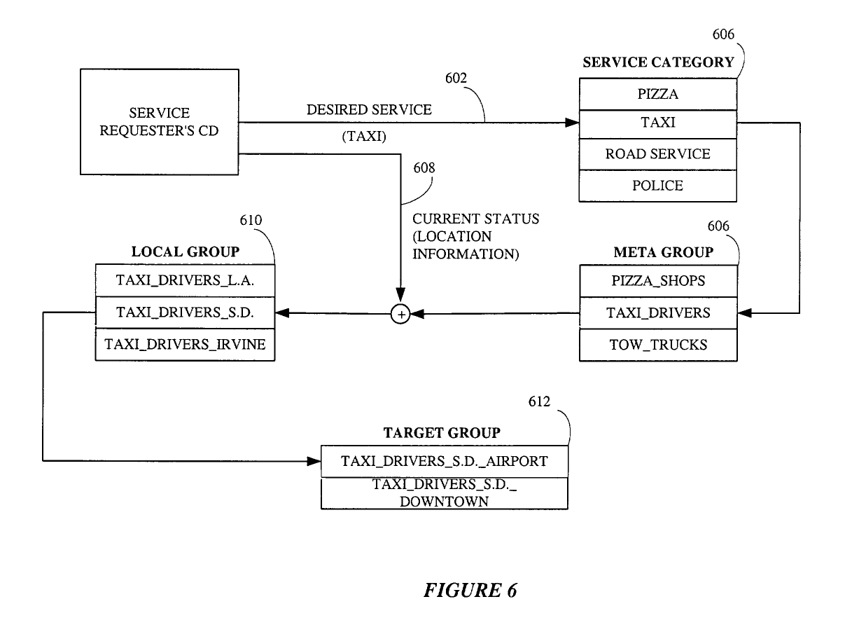

FIG. 6 shows a mapping diagram for identifying a target group of service providers for a desired service, according to one embodiment. After a service requester selects a desired service category, the service requester's CD provides an indication of the selected service 602 to a group call server. The group call server matches the selected service category with a list of service categories 604. The list of service categories may be kept in the group call server or in another entity in the network. Based on the selected service category, the group call server obtains a Meta group of providers 606 for the selected service. For example, for a selected service category of “taxi,” the group call server determines a Meta group 606, which may be identified by “Taxi_Drives” that designates all taxi drivers that have registered with the group call server to be included in such group call services.

In one embodiment, the requester's CD may also send the current status 608, e.g., current location, direction, and/or speed, of the requester's CD to the group call server. The group call server may use the current status of the requester's CD and the Meta group of providers for the desired service to determine a local group of providers 610 for the desired service. For example, if the location information indicates that the requester's CD is located in the city of San Diego (S.D.), the group call server determines a local group, which may be identified by “Taxi_Drivers_S.D.” that designates the taxi drivers in the city of San Diego who have registered with the group call server. Further, if the location information more accurately indicates that the requester's CD is located in the airport section of the city of San Diego, the group call server determines a group of providers 612, which may be identified by “Taxi_Drivers_S.D.₁₃ Airport” that designates the taxi drivers currently located in or around the airport section of the city of San Diego.

The group call server may determine a local group of providers of the desired service based on a current status of the requester's CD in several ways. In one embodiment, the group call server determines the target group of service providers based on the current location and /or current speed of movement of the requester's CD. In one embodiment, the target group includes a predetermined or fixed group of providers of the desired service, which may be mapped to the current location of the requester's CD. In one embodiment, the target group is formed dynamically from a group of available providers of the desired service, whose current locations are close or closest to the current location of the requester's CD. In one embodiment, the group includes a group of providers of the desired service who are currently within a region around the current location of the requester's CD. The region may be an area defined by a predetermined radius around the current location of the requester's CD. The region may be a fixed area around the current location of the requester's CD, or a dynamically configured area based on the current location of the requester's CD, the current speed of movement of the requester's CD, and/or availability of service providers who are close to the current location of the requester's CD.

Therefore, the disclosed embodiments provide for instantly joining a requester of a desired service to a local group of available providers for the desired service, based on the current location and/or speed of movement of the requester. Advantageously, the requester of the desired service does not need to carry phone numbers for the providers of the desired service, dos not need to search through such phone numbers for a nearby or local service provider, and does not need to individually call each service provider for obtaining information about the desired service. Additionally, the requester is instantly put in contact with a group of providers who are located in the same neighborhood that the requester is located, even when the requester moves and its current location changes.

Those of skill in the art would understand that information and signals may be represented using any of a variety of different technologies and protocols. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium is coupled to the processor, such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The description of the disclosed embodiments is provided to enable any person skilled in the art to make or use the present invention. Various modifications to these embodiments may be readily apparent to those skilled in the art, and the generic principles defined herein may be applied to other embodiments, e.g., in an instant messaging service or any general wireless data communication applications, without departing from the spirit or scope of the invention. Thus, the present invention is not intended to be limited to the embodiments shown herein but is to be accorded the widest scope consistent with the principles and novel features disclosed herein. The word “exemplary” is used exclusively herein to mean “serving as an example, instance, or illustration.” Any embodiment described herein as “exemplary” is not necessarily to be construed as preferred or advantageous over other embodiments.

1. A method in a group communication server for joining a communication device (CD) to a group call in a wireless communication network, the method comprising:
receiving a request from the CD for a desired service;
determining a current status of the CD;
determining a group of providers for the desired service based on the current status; and
joining the CD to the group.

2. The method of claim 1, wherein said determining the current status includes receiving the current status from the CD.

3. The method of claim 1, wherein said determining the current status includes determining a current location of the CD.

4. The method of claim 1, wherein said determining the group includes determining a predetermined group of providers for the desired service.

5. The method of claim 1, wherein said determining the group includes determining a dynamically formed group of providers for the desired service.

6. The method of claim 1, wherein said determining the group includes determining a group of available providers for the desired service.

7. The method of claim 3, wherein said determining the group includes determining a group of providers in a predetermined region around the current location of the CD.

8. A method in a communication device (CD) for joining a group call in a wireless communication network, the method comprising:
sending a request from the CD to a group call server (GCS) for a desired service;
providing a current status of the CD to the GCS; and
receiving a response indicating that the GCS has joined the CD to a group of providers for the desired service based on the current status.

9. The method of claim 8, wherein said providing the current status includes providing a current location of the CD.

10. The method of claim 8, wherein said group is determined based on the current status of the CD.

11. The method of claim 8, wherein said group is determined based on a predetermined group of providers for the desired service.

12. The method of claim 8, wherein said group is determined based on a dynamically formed group of providers for the desired service.

13. The method of claim 8, wherein said group is determined based on a group of available providers for the desired service.

14. The method of claim 9, wherein said group is determined based on a group of providers in a predetermined region around the current location of the CD.

15. A computer-readable medium embodying a method for joining a communication device (CD) to a group call in a wireless communication network, the method comprising:
receiving a request from the CD for a desired service;
determining a current status of the CD;
determining a group of providers for the desired service based on the current status; and
joining the CD to the group.

16. The computer-readable medium of claim 15, wherein said determining the current status includes receiving the current status from the CD.

17. The computer-readable medium of claim 15, wherein said determining the current status includes determining a current location of the CD.

18. The computer-readable medium of claim 15, wherein said determining the group includes determining a predetermined group of providers for the desired service.

19. The computer-readable medium of claim 15, wherein said determining the group includes determining a dynamically formed group of providers for the desired service.

20. The computer-readable medium of claim 15, wherein said determining the group includes determining a group of available providers for the desired service.

21. The computer-readable medium of claim 17, wherein said determining the group includes determining a group of providers in a predetermined region around the current location of the CD.

22. A computer-readable medium in a communication device (CD) for joining a group call in a wireless communication network, the method comprising:
sending a request from the CD to a group call server (GCS) for a desired service;
providing a current status of the CD to the GCS; and
receiving a response indicating that the GCS has joined the CD to a group of providers for the desired service based on the current status.

23. The computer-readable medium of claim 22, wherein said providing the current status includes providing a current location of the CD.

24. The computer-readable medium of claim 22, wherein said group is determined based on the current status of the CD.

25. The computer-readable medium of claim 22, wherein said group is determined based on a predetermined group of providers for the desired service.

26. The computer-readable medium of claim 22, wherein said group is determined based on a dynamically formed group of providers for the desired service.

27. The computer-readable medium of claim 22, wherein said group is determined based on a group of available providers for the desired service.

28. The computer-readable medium of claim 23, wherein said group is determined based on a group of providers in a predetermined region around the current location of the CD.

29. A server for joining a communication device (CD) to a group call in a wireless communication network, comprising:
means for receiving a request from the CD for a desired service;
means for determining a current status of the CD;
means for determining a group of providers for the desired service based on the current status; and
means for joining the CD to the group.

30. The server of claim 29, wherein said means for determining the current status includes means for receiving the current status from the CD.

31. The server of claim 29, wherein said means for determining the current status includes means for determining a current location of the CD.

32. The server of claim 29, wherein said means for determining the group includes means for determining a predetermined group of providers for the desired service.

33. The server of claim 29, wherein said means for determining the group includes means for determining a dynamically formed group of providers for the desired service.

34. The server of claim 29, wherein said means for determining the group includes means for determining a group of available providers for the desired service.

35. The server of claim 31, wherein said means for determining the group includes means for determining a group of providers in a predetermined region around the current location of the CD.

36. A communication device (CD) for joining a group call in a wireless communication network, comprising:
means for sending a request from the CD to a group call server (GCS) for a desired service;
means for providing a current status of the CD to the GCS; and
means for receiving a response indicating that the GCS has joined the CD to a group of providers for the desired service based on the current status.

37. The communication device of claim 36, wherein said means for providing the current status includes means for providing a current location of the CD.

38. The communication device of claim 36, wherein said group is determined based on the current status of the CD.

39. The communication device of claim 36, wherein said group is determined based on a predetermined group of providers for the desired service.

40. The communication device of claim 36, wherein said group is determined based on a dynamically formed group of providers for the desired service.

41. The communication device of claim 36, wherein said group is determined based on a group of available providers for the desired service.

42. The communication device of claim 37, wherein said group is determined based on a group of providers in a predetermined region around the current location of the CD.

43. An server for joining a communication device (CD) to a group call in a wireless communication network, comprising:
a memory unit;
a receiver;
a transmitter; and
a processor coupled to the memory unit, the receiver, and the transmitter, the processor being capable of:
receiving a request from the CD for a desired service;
determining a current status of the CD;
determining a group of providers for the desired service based on the current status; and
joining the CD to the group.

44. The server of claim 43, wherein said determining the current status includes receiving the current status from the CD.

45. The server of claim 43, wherein said determining the current status includes determining a current location of the CD.

46. The server of claim 43, wherein said determining the group includes determining a predetermined group of providers for the desired service.

47. The server of claim 43, wherein said determining the group includes determining a dynamically formed group of providers for the desired service.

48. The server of claim 43, wherein said determining the group includes determining a group of available providers for the desired service.

49. The server of claim 45, wherein said determining the group includes determining a group of providers in a predetermined region around the current location of the CD.

50. A communication device (CD) for joining a group call in a wireless communication network, comprising:
a memory unit;
a receiver;
a transmitter; and
a processor coupled to the memory unit, the receiver, and the transmitter, the processor being capable of:
sending a request from the CD to a group call server (GCS) for a desired service;
providing a current status of the CD to the GCS; and
receiving a response indicating that the GCS has joined the CD to a group of providers for the desired service based on the current status.

51. The communication device of claim 50, wherein said providing the current status includes providing a current location of the CD.

52. The communication device of claim 50, wherein said group is determined based on the current status of the CD.

53. The communication device of claim 50, wherein said group is determined based on a predetermined group of providers for the desired service.

54. The communication device of claim 50, wherein said group is determined based on a dynamically formed group of providers for the desired service.

55. The communication device of claim 50, wherein said group is determined based on a group of available providers for the desired service.

56. The communication device of claim 51, wherein said group is determined based on a group of providers in a predetermined region around the current location of the CD.
